(19) United States
(12) Patent Application Publication
(10) Pub. No.: US 2018/0348559 A1
(43) Pub. Date: Dec. 6, 2018

(54) ARRAY SUBSTRATE, LIQUID CRYSTAL DISPLAY PANEL, AND LIQUID CRYSTAL DISPLAY DEVICE

(71) Applicant: Shenzhen China Star Optoelectronics Semiconductor Display Technology Co., Ltd., Shenzhen, Guangdong (CN)

(72) Inventor: Jianhong CHEN, Shenzhen, Guangdong (CN)

(73) Assignee: Shenzhen China Star Optoelectronics Semiconductor Display Technology Co., Ltd., Shenzhen, Guangdong (CN)

(21) Appl. No.: 15/568,883

(22) PCT Filed: Jun. 26, 2017
(86) PCT No.: PCT/CN2017/089935

§ 371 Date: Oct. 24, 2017

(30) Foreign Application Priority Data
Jun. 5, 2017 (CN) 201710412913.8

(51) Int. Cl. G02F 1/1368; G02F 1/1333; G02F 1/1362

(52) U.S. Cl. CPC G02F 1/1368; G02F 1/133345; G02F 1/136227; G02F 2001/13606; G02F 2201/40; G02F 2001/136222; G02F 1/136286

(57) ABSTRACT

An array substrate, a liquid-crystal display (LCD) panel, and a LCD device are disclosed. The organic insulating layers are between the color resists layer and the first insulating layer and/or between the color resists layer and the third metal layer. Therefore, the influence of display quality produced by a stacking uplift of a junction of the color resists may be eliminated, and a pixel aperture ratio may be raised.

### BACKGROUND OF THE INVENTION

### 1. Field of the Invention

The present disclosure relates to liquid crystal display technology, and more particularly to an array substrate, a liquid crystal display (LCD) panel, and a LCD device.

### 2. Discussion of the Related Art

In a contracture of a liquid crystal display (LCD) panel using a Color Filter on Array (COF) technology, a color resists layer is mounted on one side of an array substrate. Color resists respectively having different colors may overlap at a junction of the color resists between two adjacent pixels, and the junction may have a stacking uplift. Since transmittances of the color resists having different colors are different, display quality of the LCD panel may be influence. In addition, a pixel has a Thin Film Transistor (TFT) area and an aperture display area. When a gray scale voltage is applied to the TFT, parasitic capacitances may be form between each two of metal layers of the array substrate. Voltages produced by capacitive coupling effect of the parasitic capacitances may pull down the gray scale voltage received by a pixel electrode, and an aperture ratio may be influence. Therefore, how to decrease the parasitic capacitances is research trends for raising pixel aperture ratio.

### SUMMARY

The present disclosure relates to an array substrate, a liquid crystal display (LCD) panel, and a LCD device that can eliminate influence of display quality produced by a stacking uplift of a junction of the color resists, and that can raise pixel aperture ratio.

An array substrate of an embodiment of the claimed invention includes a substrate base, and a first metal layer, a first insulating layer, a semiconductor layer, a second metal layer, a second insulating layer, a color resists layer, and a third metal layer formed on the substrate base in sequence. The first metal layer configured to form a gate of a thin-film transistor (TFT) of the array substrate. The second metal layer is configured to form a source and a drain of the TFT. The third metal layer is configured to form pixel electrodes of the array substrate. The array substrate further includes at least one of a first organic insulating layer and a second organic insulating layer; wherein the first organic insulating layer is configured between the color resists layer and the second insulating layer; wherein the second organic insulating layer is configured between the color resists layer and the third metal layer.

An array substrate of a liquid-crystal display (LCD) panel of an embodiment of the claimed invention includes a substrate base, and a first metal layer, a first insulating layer, a semiconductor layer, a second metal layer, a second insulating layer, a color resists layer, and a third metal layer formed on the substrate base in sequence. The first metal layer of the array substrate is configured to form a gate of a thin-film transistor (TFT) of the array substrate. The second metal layer of the array substrate is configured to form a source and a drain of the TFT. The third metal layer of the array substrate is configured to form pixel electrodes of the array substrate. The array substrate further includes at least one of a first organic insulating layer and a second organic insulating layer; wherein the first organic insulating layer is configured between the color resists layer and the second insulating layer; wherein the second organic insulating layer is configured between the color resists layer and the third metal layer.

A liquid-crystal display (LCD) device of an embodiment of the claimed invention includes a LCD panel and a backlight module providing lights to the LCD panel. An array substrate of the LCD panel includes a substrate base, and a first metal layer, a first insulating layer, a semiconductor layer, a second metal layer, a second insulating layer, a color resists layer, and a third metal layer formed on the substrate base in sequence. The first metal layer of the array substrate is configured to form a gate of a thin-film transistor (TFT) of the array substrate. The second metal layer of the array substrate is configured to form a source and a drain of the TFT. The third metal layer of the array substrate is configured to form pixel electrodes of the array substrate. The array substrate further includes at least one of a first organic insulating layer and a second organic insulating layer; wherein the first organic insulating layer is configured between the color resists layer and the second insulating layer; wherein the second organic insulating layer is configured between the color resists layer and the third metal layer.

Beneficial effect: The claimed invention designs that the first organic insulating layer mounted between the color resists layer and the second insulating layer, and/or that the second organic insulating layer mounted between the color resists layer and the third metal layer. Therefore, a distance between the second metal layer and the third metal layer and a distance between the first metal layer and the third metal layer may be increased to decrease parasitic capacitances between the metal layers, and the pixel aperture ratio may be raised. In addition, the second organic insulating layer mounted on the color resists layer is equivalent to flattening an upper surface of the color resists layer. Therefore, the influence of display quality produced by a stacking uplift of a junction of the color resists may be eliminated.

### BRIEF DESCRIPTION OF THE DRAWINGS

FIG. 1 is a structure sectional view of a LCD panel in accordance with one embodiment of the present disclosure.

FIG. 2 is a schematic view of a pixel structure of the LCD panel of FIG. 1.

FIG. 3 is a structure top view of a pixel area of an array substrate in accordance with one embodiment of the present disclosure.

FIG. 4 is a structure sectional view of the A-A line shown in the pixel area of FIG. 3.

FIG. 5 is a structure sectional view of the B-B line shown in the pixel area of FIG. 3.

FIGS. 6 and 7 are structure sectional views of an array substrate in accordance with another embodiment of the present disclosure.

FIG. 8 is a structure sectional view of a LCD device in accordance with one embodiment of the present disclosure.

### DETAILED DESCRIPTION OF THE EMBODIMENTS

Embodiments of the invention will now be described more fully hereinafter with reference to the accompanying drawings, in which embodiments of the invention are shown.

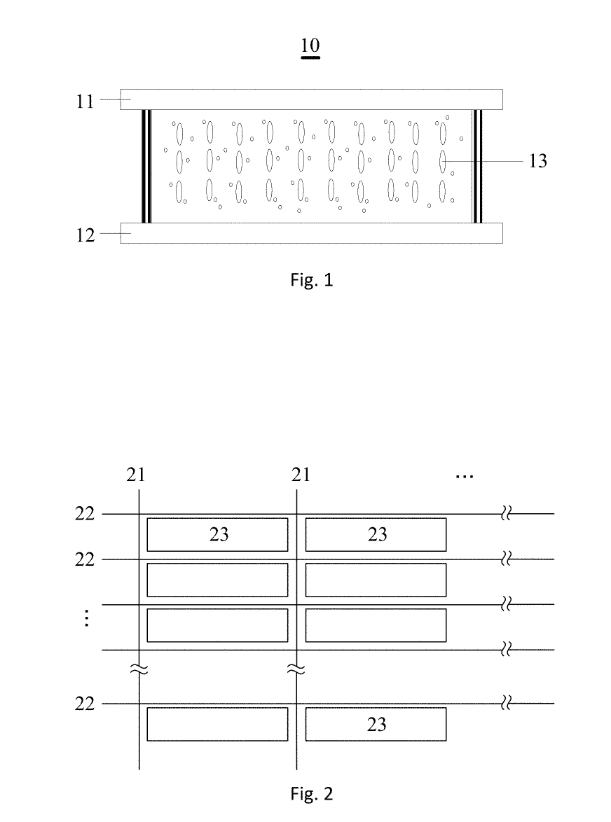

With reference to FIG. 1, FIG. 1 shows a liquid-crystal display (LCD) panel in accordance with one embodiment of the present disclosure. The LCD panel 10 may using Vertical Alignment (VA) technology. The LCD panel 10 includes a color filter (CF) substrate 11, an array substrate 12, liquid crystal molecules 13 filled between the CF substrate 11 and the array substrate 12. The liquid crystal molecules 13 is configured in a liquid crystal box formed by stacking the CF substrate 11 and the array substrate 12.

The CF substrate 11 is configured common electrodes. The common electrodes may be a transparent conductive film, such as an Indium Tin Oxide (ITO) film.

Further with reference to FIG. 2, the array substrate 12 includes a plurality of data wires 21 along with a column direction, a plurality of scan wires 22 along with a row direction, and a plurality of pixel areas 23 defined by the data wires 21 and the scan wires 22. Each of the pixel area 23 connects to the corresponding one of the data wires 21 and the corresponding one of the scan wires 22. The scan wires 22 are respectively connected to a gate driver, and respectively provide scan voltages to the pixel areas 23. The data wires 21 are respectively connected to a source driver, and respectively provide gray scale voltages to the pixel areas 23. Since structures of the pixel areas 23 are equal, the following description takes one pixel area 23 for example.

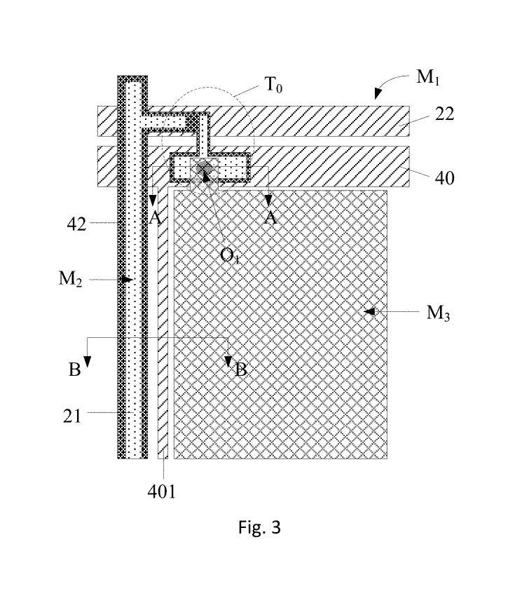

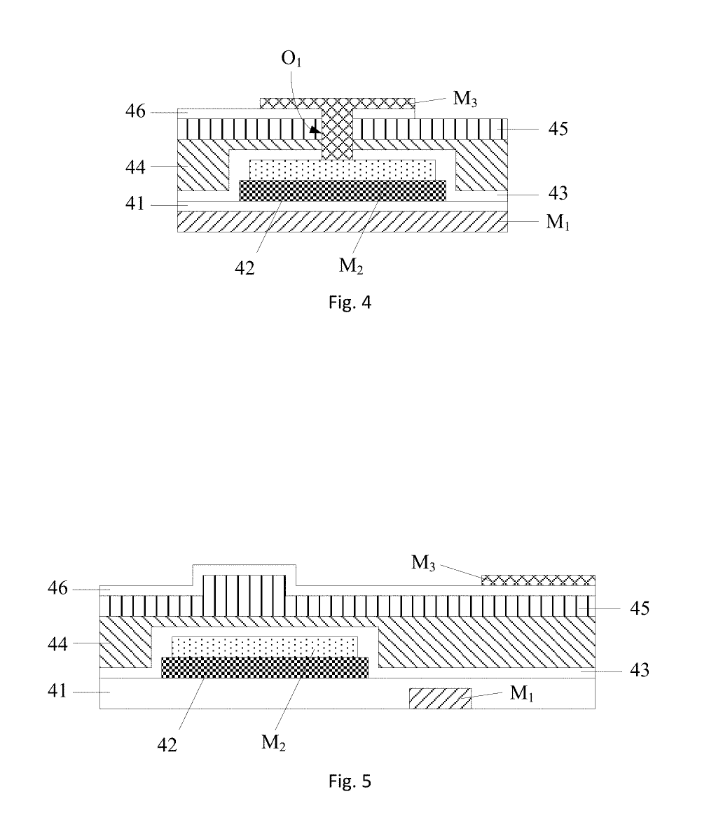

With reference to FIG. 3, FIG. 4, and FIG. 5, the array substrate 12 includes a substrate base, and layer structures formed on the substrate base in sequence. The layer structures includes a first metal layer M1, a first insulating layer 41, a semiconductor layer 42, a second metal layer M2, a second insulating layer 43, a organic insulating layer 44, a color resists layer 45, a third insulating layer 46, and a third metal layer M3 formed on the substrate base in sequence.

The first metal layer M1 is configured to form the scan wires 22, a gate of a TFT T0, a common electrode 40, and wires 401. The wires 401 span over an active area of the array substrate 12, and connect to the common electrode of one side of the array substrate 12 in a rim of the active area to receive common voltage signals. The common electrode 40 and pixel electrodes of the array substrate 12 are stacked by insulating layers between the common electrode 40 and the pixel electrodes to form a storage capacitance of the array substrate 12.

The first insulating layer 41 is a gate insulating layer, and covers on the first metal layer M1.

The second metal layer M2 is configured to form the data wires 21, a source and a drain of the TFT T0.

The third metal layer M3 is configured to form the pixel electrode of the array substrate 12.

In the embodiment, at least one connecting hole O1 is formed through the third insulating layer 46, the color resists layer 45, the organic insulating layer 44, and the second insulating layer 43. The drain of the TFT T0 is exposed through the connecting hole O1. The third metal layer M3 covers the connecting hole O1 to connect to the second metal layer M2. Therefore, the third metal layer M3 connects to the drain of the TFT T0.

In the prior art, only the second insulating layer 43, the color resists layer 45, and the third insulating layer 46 are mounted between the second metal layer M2 and the third metal layer M3. The embodiment further includes the organic insulating layer 44 mounted between the second metal layer M2 and the third metal layer M3. Therefore, a distance between the second metal layer M2 and the third metal layer M3 and a distance between the first metal layer M1 and the third metal layer M3 may be increased to decrease parasitic capacitances between the second metal layer M2 and the third metal layer M3, and parasitic capacitances between the first metal layer M1 and the third metal layer M3. Pixel aperture ratio may be raised.

The organic insulating layer 44 covers the second insulating layer 43, and materials of the organic insulating layer 44 comprises resin.

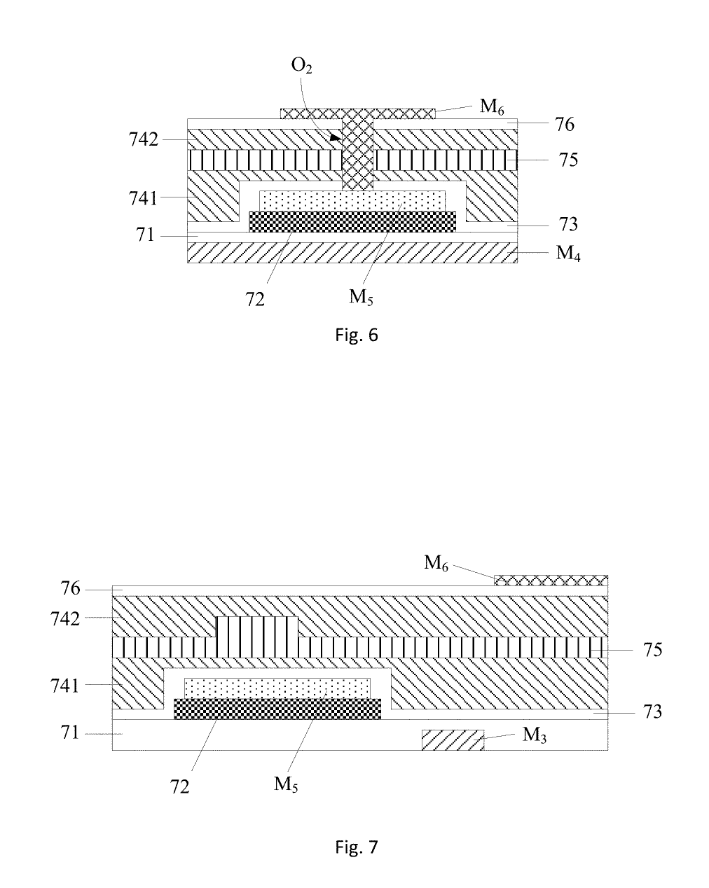

The present disclosure further provides an array substrate of another embodiment of the LCD panel 10. FIG. 6 is a first structure sectional view of the array substrate of the embodiment, and the first structure sectional view of FIG. 6 is a sectional view along with the A-A line shown in FIG. 3. FIG. 7 is a second structure sectional view of the array substrate of the embodiment, and the structure sectional view of FIG. 7 is a sectional view along with the B-B line shown in FIG. 3.

With reference to FIG. 6 and FIG. 7, the array substrate 12 includes a substrate base, and layer structures formed on the substrate base in sequence. The layer structures includes a first metal layer M4, a first insulating layer 71, a semiconductor layer 72, a second metal layer M5, a second insulating layer 73, a first organic insulating layer 741, a second organic insulating layer 742, a color resists layer 75, a third insulating layer 76, and a third metal layer M6 formed on the substrate base in sequence.

The first metal layer M4 is configured to form the scan wires 22, the gate of TFT T0, the common electrodes, and the wires. The common electrodes and the wires are same as the common electrode 40 and the wires 401 shown in FIG. 3.

The first insulating layer 71 is a gate insulating layer, and covers on the first metal layer M4.

The second metal layer M5 is configured to form the data wires 21, the source and the drain of the TFT T0.

The third metal layer M6 is configured to form the pixel electrode of the array substrate 12.

In the embodiment, at least one connecting hole O2 is formed through the third insulating layer 76, the second organic insulating layer 742, the color resists layer 75, the first organic insulating layer 741, and the second insulating layer 73. The drain of the TFT T0 is exposed through the connecting hole O2. The third metal layer M6 covers the connecting hole O2 to connect to the second metal layer M5. Therefore, the third metal layer M6 connects to the drain of the TFT T0.

In the prior art, only the second insulating layer 73, the color resists layer 75, and the third insulating layer 76 are mounted between the second metal layer M5 and the third metal layer M6. The embodiment further includes the first organic insulating layer 741 and the second organic insulating layer 742 mounted between the second metal layer M5 and the third metal layer M6. Therefore, a distance between the second metal layer M5 and the third metal layer M6 and a distance between the first metal layer M4 and the third metal layer M6 may be increased to decrease parasitic capacitances between the second metal layer M5 and the third metal layer M6, and parasitic capacitances between the first metal layer M4 and the third metal layer M6. Pixel aperture ratio may be raised. In addition, the second organic insulating layer 742 mounted on the color resists layer 75 is equivalent to flattening an upper surface of the color resists layer 75. Therefore, the influence of display quality of the LCD panel 10 produced by a stacking uplift of a junction of the color resists 75 may be eliminated.

The first organic insulating layer 741 and the second organic insulating layer 742 of the embodiment are a whole surface structure covering two sides of the color resists layer 75, and materials of the first organic insulating layer 741 and the second organic insulating layer 742 include resin.

Further with reference of FIG. 6 and FIG. 7, based on basis of the embodiment, the present disclosure may not include the third insulating layer 76. Only the second organic insulating layer 742 is mounted between the color resists layer 75 and the third metal layer M6. The second organic insulating layer 742 may achieve the above invention object, and further achieves an insulating function of the third insulating layer 76.

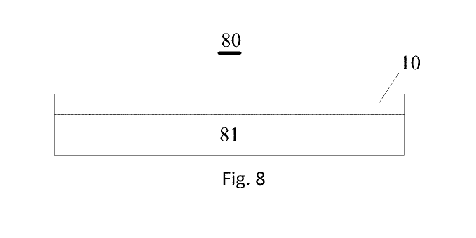

The present disclosure further provides a liquid-crystal display (LCD) device 80 as shown in FIG. 8. The LCD device 80 includes the LCD panel 10 and a backlight module 81 providing lights to the LCD panel 10. Since the LCD device 80 includes the array substrate 12, the LCD device 80 has beneficial effect as above mentioned.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate, comprising:
a substrate base, and a first metal layer, a first insulating layer, a semiconductor layer, a second metal layer, a second insulating layer, a color resists layer, and a third metal layer formed on the substrate base in sequence;
wherein the first metal layer configured to form a gate of a thin-film transistor (TFT) of the array substrate;
wherein the second metal layer configured to form a source and a drain of the TFT;
wherein the third metal layer configured to form pixel electrodes of the array substrate; and
wherein the array substrate further comprises at least one of a first organic insulating layer and a second organic insulating layer; wherein the first organic insulating layer is configured between the color resists layer and the second insulating layer; wherein the second organic insulating layer is configured between the color resists layer and the third metal layer.

2. The array substrate as claimed in claim 1, further comprising:
both of the first organic insulating layer and the second organic insulating layer;
at least one connecting hole formed through the second organic insulating layer, the color resists layer, the first organic insulating layer, and the second insulating layer;
wherein the third metal layer covers the at least one connecting hole to connect to the second metal layer through the at least one connecting hole.

3. The array substrate as claimed in claim 1, further comprising:
a third insulating layer, configured between the color resists layer and the third metal layer;
wherein the third insulating layer is configured between the second organic insulating layer and the color resists layer.

4. The array substrate as claimed in claim 3, further comprising:
both of the first organic insulating layer and the second organic insulating layer;
at least one connecting hole formed through third insulating layer, the second organic insulating layer, the color resists layer, the first organic insulating layer, and the second insulating layer;
wherein the third metal layer covers the at least one connecting hole to connect to the second metal layer through the at least one connecting hole.

5. The array substrate as claimed in claim 1, wherein a surface of the second organic insulating layer facing away the color resists layer is a flat surface.

6. The array substrate as claimed in claim 1, wherein materials of the first organic insulating layer and the second organic insulating layer comprises resin.

7. The array substrate as claimed in claim 1, wherein the first metal layer is configured to form common electrodes and wires connecting to the common electrodes;
wherein the wires span over an active area of the array substrate, and connect to common voltage signals in a rim of the active area.

8. A liquid-crystal display (LCD) panel, comprising a color filter substrate, and an array substrate having an interval with the color filter substrate;
wherein the array substrate comprises a substrate base, and a first metal layer, a first insulating layer, a semiconductor layer, a second metal layer, a second insulating layer, a color resists layer, and a third metal layer formed on the substrate base in sequence;
wherein the first metal layer of the array substrate configured to form a gate of a thin-film transistor (TFT) of the array substrate;
wherein the second metal layer of the array substrate configured to form a source and a drain of the TFT;
wherein the third metal layer of the array substrate configured to form pixel electrodes of the array substrate; and
wherein the array substrate further comprises at least one of a first organic insulating layer and a second organic insulating layer; wherein the first organic insulating layer is configured between the color resists layer and the second insulating layer; wherein the second organic insulating layer is configured between the color resists layer and the third metal layer.

9. The LCD panel as claimed in claim 8, wherein the array substrate comprises:
both of the first organic insulating layer and the second organic insulating layer;
at least one connecting hole formed through the second organic insulating layer, the color resists layer, the first organic insulating layer, and the second insulating layer;
wherein the third metal layer covers the at least one connecting hole to connect to the second metal layer through the at least one connecting hole.

10. The LCD panel as claimed in claim 8, wherein the array substrate comprises:
a third insulating layer, configured between the color resists layer and the third metal layer;
wherein the third insulating layer is configured between the second organic insulating layer and the color resists layer.

11. The LCD panel as claimed in claim 10, wherein the array substrate comprises:
both of the first organic insulating layer and the second organic insulating layer;
at least one connecting hole formed through third insulating layer, the second organic insulating layer, the color resists layer, the first organic insulating layer, and the second insulating layer;
wherein the third metal layer covers the at least one connecting hole to connect to the second metal layer through the at least one connecting hole.

12. The LCD panel as claimed in claim 8, wherein a surface of the second organic insulating layer of the array substrate facing away the color resists layer of the array substrate is a flat surface.

13. The LCD panel as claimed in claim 8, wherein materials of the first organic insulating layer of the array substrate and the second organic insulating layer of the array substrate comprises resin.

14. The LCD panel as claimed in claim 8, wherein the first metal layer of the array substrate is configured to form common electrodes and wires connecting to the common electrodes;
wherein the wires span over an active area of the array substrate, and connect to common voltage signals in a rim of the active area.

15. The LCD panel as claimed in claim 14, wherein the color filter substrate comprises the common electrodes;
wherein the first metal layer of the array substrate connects to the common electrodes of the color filter substrate to receive the common voltage signals applied to the common electrodes.

16. A liquid-crystal display (LCD) device, comprising a LCD panel and a backlight module providing lights to the LCD panel;
wherein the LCD panel comprises a color filter substrate, and an array substrate having an interval with the color filter substrate;
wherein the array substrate comprises a substrate base, and a first metal layer, a first insulating layer, a semiconductor layer, a second metal layer, a second insulating layer, a color resists layer, and a third metal layer formed on the substrate base in sequence;
wherein the first metal layer of the array substrate configured to form a gate of a thin-film transistor (TFT) of the array substrate;
wherein the second metal layer of the array substrate configured to form a source and a drain of the TFT;
wherein the third metal layer of the array substrate configured to form pixel electrodes of the array substrate; and
wherein the array substrate further comprises at least one of a first organic insulating layer and a second organic insulating layer; wherein the first organic insulating layer is configured between the color resists layer and the second insulating layer; wherein the second organic insulating layer is configured between the color resists layer and the third metal layer.

17. The LCD device as claimed in claim 16, wherein the array substrate comprises:
both of the first organic insulating layer and the second organic insulating layer;
at least one connecting hole formed through the second organic insulating layer, the color resists layer, the first organic insulating layer, and the second insulating layer;
wherein the third metal layer covers the at least one connecting hole to connect to the second metal layer through the at least one connecting hole.

18. The LCD device as claimed in claim 16, wherein the array substrate comprises:
a third insulating layer, configured between the color resists layer and the third metal layer;
wherein the third insulating layer is configured between the second organic insulating layer and the color resists layer.

19. The LCD device as claimed in claim 18, wherein the array substrate comprises:
both of the first organic insulating layer and the second organic insulating layer;
at least one connecting hole formed through third insulating layer, the second organic insulating layer, the color resists layer, the first organic insulating layer, and the second insulating layer;
wherein the third metal layer covers the at least one connecting hole to connect to the second metal layer through the at least one connecting hole.

20. The LCD panel as claimed in claim 16, wherein the color filter substrate comprises common electrodes;
wherein the first metal layer of the array substrate connects to the common electrodes of the color filter substrate to receive the common voltage signals applied to the common electrodes.
